(19) United States
(12) Patent Application Publication
(10) Pub. No.: US 2004/0182898 A1
(43) Pub. Date: Sep. 23, 2004

(54) SHORT ROOF-LINE CONNECTIVE ADAPTATION FOR A CARGO CARRIER

(75) Inventor: Kevin W. HARRIS, Beacon Falls, CT (US)

Correspondence Address: TRACY W. DRUCE, ESQ., 1496 EVANS FARM DR, MCLEAN, VA, 22101, US

(73) Assignee: THULE SWEDEN AB, Hillerstorp (SE)

(21) Appl. No.: 10/604,229

(22) Filed: Jul. 2, 2003

Related U.S. Application Data
(63) Continuation of application No. 09/755,964, filed on Jan. 6, 2001, now abandoned.
(60) Provisional application No. 60/175,164, filed on Jan. 7, 2000.

(51) Int. Cl. B60R 9/00; B60R 9/058

(52) U.S. Cl. 224/329

(57) ABSTRACT

A vehicular cargo carrying arrangement having a cargo carrier secured by an anchor assembly to a transporting vehicle. The arrangement includes a transporting vehicle and a cargo carrier releasably interconnected by an anchor assembly, the transporting vehicle having a receiving arrangement for the anchor assembly. The anchor assembly has a pair of spaced apart connecting members, each of the connecting members being releasably attached between the cargo carrier and the transporting vehicle. At least one of the connecting members is adapted to accommodate fixation of a spanning member between the pair of spaced apart connecting members. A spanning member is connected between the pair of spaced apart connecting members and is configured to accept a securement member thereupon by a slip connection.

### CROSS REFERENCE TO RELATED APPLICATIONS

This patent application is a continuation of U.S. patent application Ser. No. 09/755,964 entitled SHORT ROOF-LINE CONNECTIVE ADAPTATION FOR A CARGO CARRIER filed Jan. 6, 2001, now abandoned, and claims the benefit of U.S. provisional application No. 60/175,164 filed Jan. 7, 2000 entitled SHORT ROOF-LINE CONNECTIVE ADAPTATION FOR A CARGO CARRIER, the disclosures of which, in their entireties, are hereby expressly incorporated by reference into the present application.

### BACKGROUND OF INVENTION

1. Technical Field

The present invention relates generally to vehicular mountable cargo carriers, and more specifically to the connective systems used for mounting cargo carriers to the roof of a transporting vehicle such as a passenger automobile.

2. Background Art

The use of cargo carriers on transporting vehicles is well known. A particularly favored location for mounting such cargo carriers is the roof of the vehicle. In many configurations, the mounting is accommodated by a system of longitudinally oriented rails, and optionally, cross-mounted load bars between the rails. Many passenger vehicles, and particularly sedans and coupes, do not typically have such accommodating mounting hardware. The owners of such vehicles do, however, often desire to carry cargo outside the vehicle either out of necessity or convenience. It is not uncommon for the interior cargo space of a passenger vehicle to be too small for all of that which is desired to be transported at any given time; or because of other load aspects, such as simultaneously carrying a maximum number of passengers in the vehicle, it is desirable to position some cargo at locations exterior to the passenger cabin in auxiliary cargo space that is provided to increase total vehicle load/cargo transporting capacity.

For those instances in which there is no support structure for mounting such a roof-top cargo carrier upon the vehicle, systems have been adapted for mounting the carrier substantially directly to the top surface of the vehicle's roof. These systems usually employ a combination of connectors, webbed belts, anchor clips and take-up buckles for properly fitting the anchor assembly between the cargo carrier and the transporting vehicle. In a standard configuration, the mentioned anchor clips are adapted to be matingly engaged upon a catch feature or lip created by the gap space between door frames of the vehicle and the roof's surface. Such anchor assemblies, however, have traditionally been limited to utilization on larger sedans, and typically those having at least four passenger doors. The reason for this limitation stems from the fact that the anchor clips find purchase for attachment to the transporting vehicle on the lip or catch formed by the described gap space between the door frames and roof.

In a four-door passenger vehicle, there are two doors on each side of the vehicle; this configuration normally provides a sufficiently long catch-space for proper placement and spacing of two anchorings from the cargo carrier to the vehicle. A certain spacing distance between the anchor points is desired on each side of the vehicle for securely fixing the carrier to the roof. If the anchors are not spaced sufficiently apart, twisting of the carrier, as a result of imposed torque forces thereupon, may result. This condition is particularly prevalent in two-door sedans and coupes. The reason is that there is only one door on each side of the vehicle and the available longitudinally oriented gap space for the anchor clips is commensurately limited. As a result, large cargo carriers have not been previously mountable to the roofs of such smaller vehicles because of their comparatively short roof-lines, a line that is normally taken as being coincident with a longitudinal axis of the vehicle and generally aligned with forward and backward directions of vehicular travel. A primary reason for not making such mountings of carriers in these temporary roof-mount configurations is that the connecting members, normally provided in pairs on each side of the vehicle, are permanently mounted to the cargo carrier body and are so widely spaced apart that clipped or hooked connections into the relatively short, forward-to-back, receiving gap space is not effective, or possible in some instances. If one of two connecting members is properly positioned to be clipped or hooked into the gap created by a single door on the side of a two-door vehicle, the other clip or anchor of the pair will be positioned longitudinally, too far away for suitable connection upon the vehicle.

In an effort to make a particular roof top cargo carrier design mountable to different vehicles, sets of attachment clips have traditionally been provided in varied configurations, each adapted to conform to the catch or receiving structures of various vehicles. Normally, any one particular clip configuration will properly fit more than one, but a limited array of vehicles. Therefore, in order to make a particular cargo carrier suitable for mounting upon more vehicles, and thereby expanding the available sales market, additional clips have been successively designed for inclusion in the provided clip sets. Each additional clip configuration, however, tends to fit fewer and fewer vehicles as the number of clips in a set grows. As a result, added clip configurations within a set, after the set has grown to a particular size, begin to provide reduced increases in the number of vehicles accommodated. Consequently, designers have been required to look toward alternative solutions which enable mounting accommodation of a larger number of vehicles with reduced modification to the cargo carrier and mounting systems.

The present system has been developed, at least in part, as a result of experience gained through the design of other types of load carriers such as those utilized for transporting sports equipment pieces upon transporting vehicles. Capitalizing on that experience, the present invention has been developed with the purpose of increasing the number of vehicles that can be utilized as carrying vehicles for currently produced cargo carriers. With this in mind, a goal has been to increase possible market exploitation without substantially changing, if at all, the design of the cargo carrier itself; an alternative which is technologically more difficult, and substantially more expensive.

It has been appreciated that two-door, or coupe-styled passenger vehicles are one of the largest market segments presently untapped when considering cargo carriers of current designs that are configured to be mounted upon four-door passenger vehicles. Through a configuration that enables the mounting of such cargo carriers to two-door passenger vehicles, substantial market expansion is gained for current cargo carrier designs. Responsively, the present invention has been developed for such market

### SUMMARY OF INVENTION

The present invention in its several disclosed embodiments alleviates the drawbacks described above with respect to conventionally designed cargo carrier systems when smaller passenger vehicles having shorter roof-lines are considered.

Of paramount importance, and initially, the anchor assembly disclosed herein makes it possible to mount a conventionally designed rooftop cargo carrier to short roof-line vehicles such as two-door passenger coupes, and possibly even picked-up truck cabs. To accommodate the vehicle's longitudinally measured short roof-line, and the commensurately short gap space between the side door frame(s) and the roofs surface, the present invention includes an adaptation which enables the two connecting members on each side of the cargo carrier to be spaced at conventional distances and still be utilized for making an appropriate attachment to the vehicle with two relatively closely spaced securing members. Still further, because at least one of the securing members is mounted on a sliding or trolleyed connection, variable positioning of that sliding securing member is made possible. Not only are benefits realized because substantially any connective spacing may be established, but also, various designs with respect to the gap space into which clipped attachment is affected may be matched.

Still further, the accommodated variations in configuration of the anchor assembly also make it possible to affect attachment to the vehicle around such obstacles as upright door frames and other impedances that may be located along the gap space and which prevent attachment at a particular longitudinal location. Further yet, based on the two disclosed and alternative embodiments, substitute connecting members may be installed on the carrier body which have been adapted for utilization according to the present invention; or existing connecting members may be reformed using the described add-on adapters which enable the connection of a spanning member between originally configured connecting members. Importantly, these adaptations provide an inexpensive modification or retrofit to existing cargo carriers that greatly expands the available sales market for these carriers without substantially altering the present configuration of the cargo carrier itself.

The beneficial effects described above apply generally to the exemplary devices and mechanisms disclosed herein for anchor assemblies adapted to secure conventionally designed cargo carriers to the roof of longitudinally short roof-line vehicles. The specific structures through which these benefits may be delivered will be described in greater detail hereinbelow.

### BRIEF DESCRIPTION OF DRAWINGS

The invention will now be described in greater detail in the following way of example only and with reference to the attached drawings, in which:

FIG. 1 is a side perspective view of an exemplary vehicle cargo carrying arrangement constructed according to the present invention, with an optional rail and cross-bar support assembly interposed between the vehicle and cargo carrier components;

FIG. 2 is a slightly modified version of the arrangement as depicted in FIG. 1, but without the optional support rail and cross-bar assembly shown, and with the vehicle deleted for clarity;

FIG. 3 is a bottom-side perspective view of an embodiment showing details of a portion of the anchor assembly, including the optional support rail and cross-bar arrangement; and

FIG. 4 is a plan view showing details of an adapted connecting member configured to be fastened to the bottom surface of a cargo carrier body.

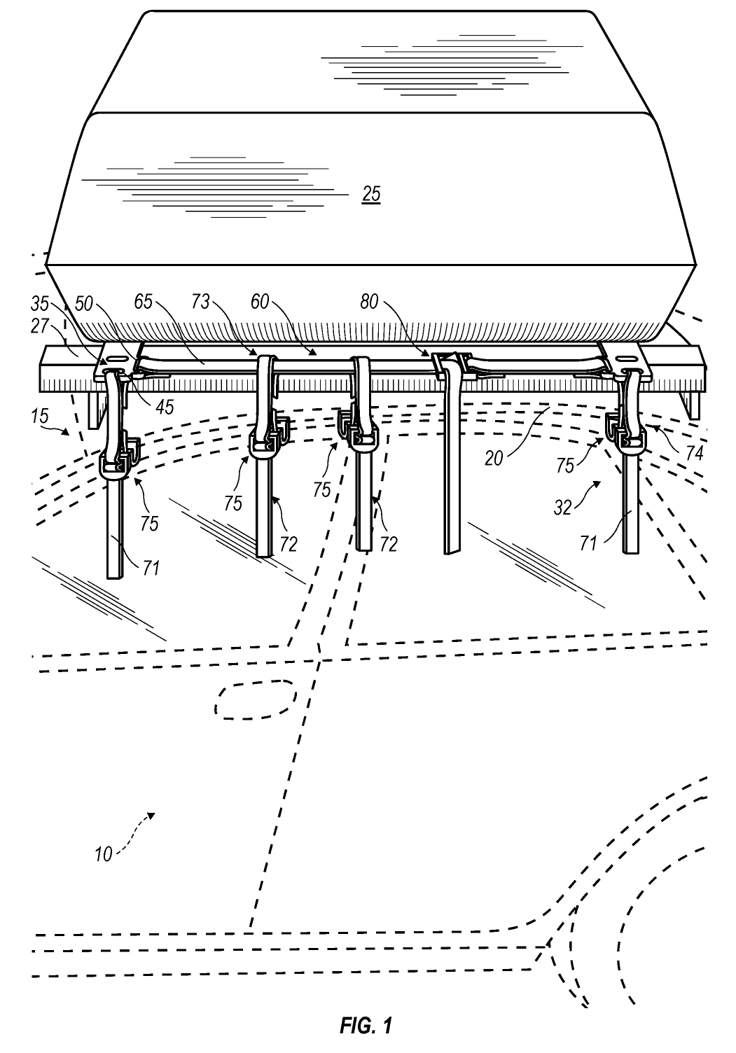

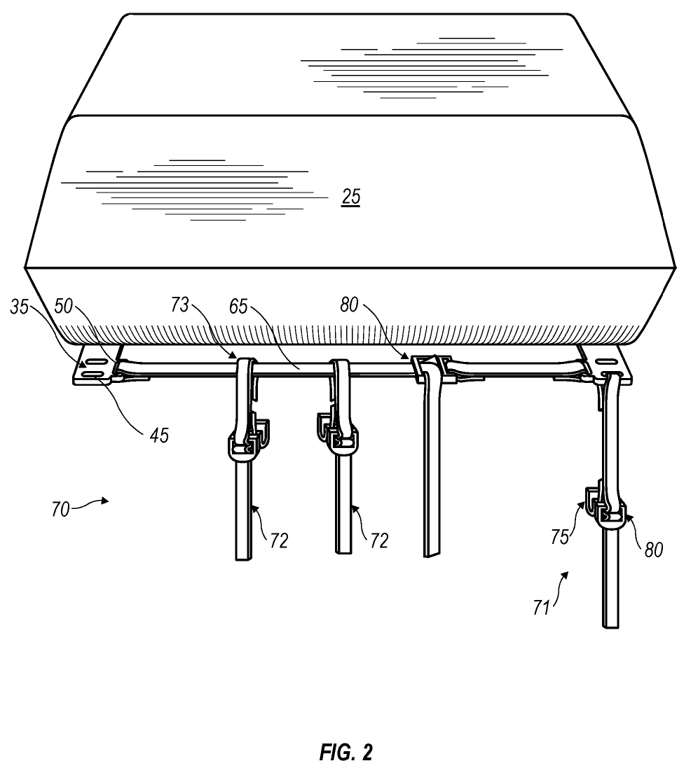

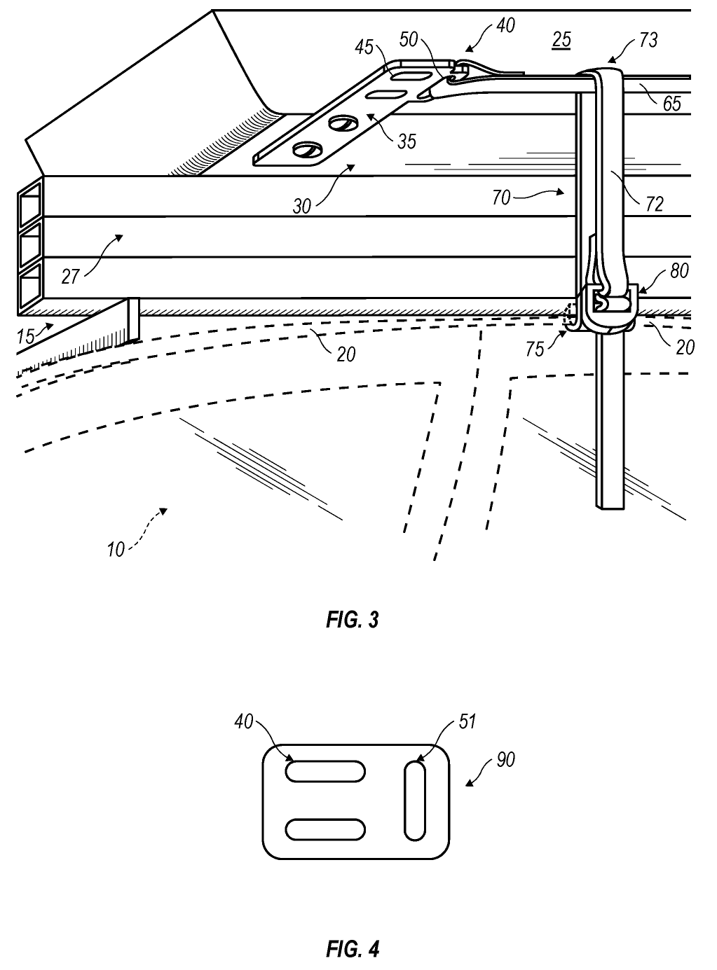

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention(s).

Referring to the Figures, in at least one embodiment, the present invention takes the form of an anchor assembly 32 adapted for securing a cargo carrier body 25 to the roof space 15 of a short roof-line transporting vehicle 10. The anchor assembly includes a pair of spaced apart connecting members 35, each of which is adapted to be attached to the cargo carrier body 25, typically at a lower surface 30 thereof which may be adapted for engagement with roof-rails 27 and/or cross-bar(s) of the vehicle 10. At least one, and preferably both, of the connecting members 35 is adapted to accommodate fixation of a spanning member 60 between the pair of spaced apart connecting members 35. The spanning member 60 is adapted to be connected between the pair of spaced apart connecting members 35 and the spanning member 60 is configured to accept a securement member 70 thereupon by a slip connection 73 thereabout.

A moveable securement member or belt 72 is slidingly engaged upon the spanning member 60 and has one end distally positionable away from the spanning member 60 that is adapted to be secured to the transporting vehicle 10. Such fixation is preferably accomplished using an anchor clip 75 of conventional configuration. The anchor clip 75 is typically adapted to catch on a vehicle recess or other suitable receiving arrangement that can exemplarily take the form of a gap space 20 in the transporting vehicle 10 formed between the door frame(s) and the roof surface of the vehicle 10, or on a rain gutter assembly projecting from the vehicle. As shown, the clip 75 is located at the end of the securement member (belt) 70 distally positionable away from the spanning member 60.

At least one stationary securement member or belt 71 is fastened upon at least one of the connecting members 35. Like the moveable securement member 70, the stationary securement member 71 has a clip-including end distally positionable away from the connecting member 35 and the spanning member 60 at the transporting vehicle 10.

Both of the pair of spaced apart connecting members 35 are adapted to accommodate fixation of the spanning member 60 therebetween. In a preferred embodiment, the spanning member 60 and the securement member(s) 70,71,72 are constructed from flexible webbed belting; in this configuration the spanning member 60 is formed by a cross-belt 65 and the securement members include a securement belt 74. A take-up device in the form of an adjustment buckle 80 is typically provided on each belt member for adjustment and tightening purposes. As illustrated, the adjustment buckle 80 and the anchor clip 75 may be integrally constructed.

Each of the connecting members 35 includes belt receiving slots 40 in which a first slotted aperture 50 extends therethrough and is oriented for accepting a looped connection of the spanning member 60 to the connecting member 35. The first slotted aperture 50 is configured so that a longitudinal axis thereof is transversely oriented to a centerline of the transporting vehicle 10 when the cargo carrier body 25 is properly mounted thereupon. Most preferably, the transverse orientation is substantially perpendicular to the longitudinal axis of the vehicle 10.

One or both of the connecting members 35 has a second slotted aperture 45 extending therethrough and oriented for accepting a looped connection of a securement member 70 to the connecting member 35. Each of the second slotted apertures 45 are configured so that a longitudinal axis thereof is oriented substantially parallel to a centerline of the transporting vehicle when the cargo carrier body is properly mounted thereupon.

In an alternative embodiment, an add-on adaptor 90 is configured to be fixed upon at least one of the pair of spaced apart connecting member 35s, where the connecting members are of conventional design, and have not been modified as described above; that is, accommodating slots 50 have not been provided. The add-on adaptor 90 has a first slotted aperture 51 extending therethrough and is configured to be oriented for accepting a looped connection of the spanning member 60 to the add-on adaptor 90. Any suitable method of connecting the add-on adaptor 90 to the connecting member may be utilized including welding, bolting, riveting, epoxying and the like.

Exemplary devices and mechanisms for anchor assemblies adapted to secure conventionally designed cargo carriers to the roof of short roof-line vehicles have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

INDUSTRIAL APPLICABILITY: The present invention finds applicability in the automotive arts, and more particularly in the cargo carrier and automotive accessory industries.

1. A vehicular cargo carrying arrangement having a cargo carrier secured by an anchor assembly to a transporting vehicle, said arrangement comprising:
a transporting vehicle and a cargo carrier releasably interconnected by an anchor assembly, said transporting vehicle having a receiving arrangement for the anchor assembly;
the anchor assembly comprising: a pair of spaced apart connecting members, each of said connecting members being releasably attached between the cargo carrier and the transporting vehicle; at least one of said connecting members adapted to accommodate fixation of a spanning member between said pair of spaced apart connecting members; and a spanning member connected between said pair of spaced apart connecting members, said spanning member configured to accept a securement member thereupon by a slip connection.

2. The vehicular cargo carrying arrangement as recited in claim 1, further comprising:
a moveable securement member slidingly engaged upon said spanning member, said securement member having an end distally positionable away from said spanning member and adapted to be secured to a transporting vehicle.

3. The vehicular cargo carrying arrangement as recited in claim 1, further comprising:
a stationary securement member fastened upon one of said connecting members, said securement member having an end distally positionable away from said spanning member and adapted to be secured to a transporting vehicle.

4. The vehicular cargo carrying arrangement as recited in claim 3, further comprising:
a moveable securement member slidingly engaged upon said spanning member, said securement member having an end distally positionable away from said spanning member and adapted to be secured to a transporting vehicle.

5. The vehicular cargo carrying arrangement as recited in claim 4 wherein both of said pair of spaced apart connecting members are adapted to accommodate fixation of said spanning member therebetween.

6. The vehicular cargo carrying arrangement as recited in claim 5 wherein said moveable spanning member, said stationary spanning member and said securement member are constructed from flexible webbed belting.

7. The vehicular cargo carrying arrangement as recited in claim 5 wherein each of said connecting members has a first slotted aperture extending therethrough and oriented for accepting a looped connection of said spanning member to said connecting member, said first slotted aperture being configured so that a longitudinal axis thereof is transversely oriented to a centerline of the transporting vehicle when the cargo carrier body is properly mounted thereupon.

8. The vehicular cargo carrying arrangement as recited in claim 5 wherein each of said connecting members has a first slotted aperture extending therethrough and oriented for accepting a looped connection of said spanning member to said connecting member, said first slotted aperture being configured so that a longitudinal axis thereof is oriented substantially perpendicular to a centerline of the transporting vehicle when the cargo carrier body is properly mounted

9. The vehicular cargo carrying arrangement as recited in claim 8 wherein each of said connecting members has a second slotted aperture extending therethrough and oriented for accepting a looped connection of said securement member to said connecting member, each of said second slotted apertures being configured so that a longitudinal axis thereof is oriented substantially parallel to a centerline of the transporting vehicle when the cargo carrier body is properly mounted thereupon.

10. The vehicular cargo carrying arrangement as recited in claim 8 wherein at least one of said pair of connecting members has a second slotted aperture extending therethrough and oriented for accepting a looped connection of said securement member to said connecting member, said second slotted aperture being configured so that a longitudinal axis thereof is oriented substantially parallel to a centerline of the transporting vehicle when the cargo carrier body is properly mounted thereupon.

11. The vehicular cargo carrying arrangement as recited in claim 4 further comprising:
a clip attached to said moveable securement member, said clip adapted to catch in a gap space on the transporting vehicle established between a door frame and a roof's surface of the vehicle.

12. The vehicular cargo carrying arrangement as recited in claim 1, further comprising:
an add-on adaptor configured to be fixed upon at least one of said pair of spaced apart connecting members, said add-on adaptor having a first slotted aperture extending therethrough and configured to be oriented for accepting a looped connection of said spanning member to said add-on adaptor.

13. The vehicular cargo carrying arrangement as recited in claim 11 wherein said clip is attached to a distal end of said moveable securement member.

14. The vehicular cargo carrying arrangement as recited in claim 3 further comprising:
a clip attached to said stationary securement member, said clip adapted to catch in a gap space on the transporting vehicle established between a door frame and a roof's surface of the vehicle.

15. The vehicular cargo carrying arrangement as recited in claim 14 wherein said clip is attached to a distal end of said stationary securement member.

16. An anchor assembly for securing a cargo carrier body to a short roof-line transporting vehicle, said anchor assembly comprising:
a pair of spaced apart connecting members, each of said connecting members being adapted to be attached to a cargo carrier body adapted for engagement with a roof rack on the transporting vehicle;
at least one of said connecting members adapted to accommodate fixation of a spanning member between said pair of spaced apart connecting members;
a spanning member adapted to be connected between said pair of spaced apart connecting members, said spanning member configured to accept a securement member thereupon by a slip connection;
a moveable securement member slidingly engaged upon said spanning member, said securement member having an end distally positionable away from said spanning member and adapted to be secured to a transporting vehicle; and
a stationary securement member fastened upon one of said connecting members, said securement member having an end distally positionable away from said spanning member and adapted to be secured to a transporting vehicle.
